(19) United States
(12) Patent Application Publication
(10) Pub. No.: US 2008/0031510 A1
(43) Pub. Date: Feb. 7, 2008

(54) Method of and apparatus for inspecting wafers in chemical mechanical polishing equipment

(76) Inventor: Young-Seok Jung, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/702,574

(22) Filed: Feb. 6, 2007

(30) Foreign Application Priority Data
Aug. 7, 2006 (KR) 2006-0074057

(51) Int. Cl. G06K 9/00; B24B 49/12; B24B 51/00

(52) U.S. Cl. 382/149

(57) ABSTRACT

The surfaces of wafers polished in CMP equipment are monitored in real time to detect a normal/abnormal state of operation of the CMP equipment. A camera is disposed alongside a path along which a wafer is transferred to a cassette stage from a cleaning unit. The camera is oriented to capture an image of the surface of the wafer which has been polished and cleaned. An image processor processes the color image of the surface of the wafer captured by the camera into data of the contrast between and color of areas of the image. A controller receives the data output by the image processor. The controller is connected to a database in which data of at least one color reference image is stored. The reference image(s) is/are correlated to process conditions of the CMP process. The controller (selectively) compares the processed color image with the color reference image that is stored in the database, and based on the comparison determines whether a defect exists in the polishing process.

### BACKGROUND OF THE INVENTION

1. Field of the Invention

The present invention relates to chemical mechanical polishing (CMP) equipment. More particularly, the present invention relates to a method of and an apparatus for inspecting a wafer that is being polished by CMP equipment.

2. Description of the Related Art

In general, a semiconductor device is manufactured by subjecting a wafer to several individual processes including a diffusion process, a chemical vapor deposition process, an oxidation process, a photolithography process, a metal deposition process, and an etching process. The processes are performed repeatedly in a particular order to form desired geometrical circuit structures on the wafer. Some of these structures produce steps at the surface of the processed wafer which can create problems in the subsequent processing of the wafer. Therefore, the semiconductor manufacturing process also includes a chemical mechanical polishing (CMP) process that polishes the wafer to remove the steps. Generally speaking, the CMP process uses both mechanical action and chemical action to polish a surface on the wafer until the surface is smooth and flat.

Conventional CMP equipment includes main polishing apparatus, a cleaning unit, and a controller. The main polishing apparatus has a platen assembly in which a polishing pad is attached to a rotating platen, a polishing head assembly that moves up and down above the platen assembly and is provided with a vacuum head for holding the wafer using suction, and a slurry supply system that supplies an abrasive slurry onto the polishing pad of the platen assembly. The cleaning unit cleans the wafer that has been polished by the main polishing apparatus. The controller controls the overall operation of the CMP equipment.

A CMP process begins by transferring a wafer to be polished to the polishing head assembly. The wafer is held by the vacuum head above the platen assembly. Then, the polishing head assembly is lowered to place the surface of the wafer to be polished in contact with the polishing pad. In this state, the platen assembly and the polishing head assembly are simultaneously rotated, and the surface of the wafer is planarized (polished) with the slurry supplied onto the polishing pad by the slurry supply system. The wafer is transferred to the cleaning unit after it is polished, and is cleaned by the cleaning unit to remove slurry and remnants of the material removed by the polishing process.

The amount of material that a CMP process will remove from any particular wafer is difficult to exactly predict. This is especially true in the case in which several layers on the wafer are to be polished because the CMP process will remove material from the layers at different rates (hereinafter referred to as removal rates). Furthermore, the amount of slurry supplied, the pressure exerted on the wafer by the polishing head, the speed (rpm) of the platen assembly and polishing head, etc. are all variable and affect the removal rate of the CMP process. Thus, the final thickness of a layer targeted by the CMP process can be different from the desired thickness.

In light of the above, test equipment is used to measure a thickness of polished wafers sampled from a lot of wafers subjected to a CMP process. That is, the sampled wafers are inspected for defects to determine whether the sampled wafers were polished correctly. If the sampled wafers are deemed normal, all of the wafers of the lot are deemed normal and are subjected to the next process in the manufacturing sequence. Regardless, some of the wafers in the lot may be defective because the removal rate can vary amongst wafers for the reasons described above. Thus, defective wafers can be passed on after the CMP process and can cause processing errors or additional defects.

### SUMMARY OF THE INVENTION

Therefore, an object of the present invention is to minimize defects that can be produced in substrates, such as wafers, undergoing a polishing (CMP) process.

A more specific object of the present invention is to provide an apparatus for and a method of inspecting substrates, such as wafers, in real time during a program of carrying out a polishing (CMP) process on the substrates.

According to one aspect of the present invention, there is provided an apparatus for inspecting wafers in chemical mechanical polishing (CMP) equipment having a main polishing unit that performs a CMP polishing process on wafers, a cleaning unit that cleans wafers polished by the main polishing unit, and a transfer device that transfers a wafer cleaned by the cleaning unit along a path from the cleaning unit to a cassette stage or the like. The apparatus includes a camera, an image processor, an electronic database (memory), and a controller.

The camera is disposed alongside the path along which a wafer is transferred by the transfer device from the cleaning unit, and is oriented to capture a color image of the surface of the wafer during the course of its transfer. The image processor is electronically connected to the camera and is operative to process color images captured by the camera and output processed images made up of data of the color and contrast of the color images captured by the camera. The database stores data of at least one color reference image. The data of each color reference image is correlated with the corresponding CMP process conditions which will produce a wafer whose surface bears an image corresponding to the color reference image. The controller is electronically connected to the image processor so as to receive the processed images output by the image processor, and is electronically connected to the database. The controller is configured to selectively compare a processed image output by the image processor with a reference image stored in the database. The controller is also configured to determine on the basis of the comparison whether a defect exists in the polishing process.

Preferably, the controller is electronically connected to the polishing unit and is operative to generate an interlock signal that shuts down the polishing unit. The controller is configured to generate the interlock signal when the processed image output by the image processor does not correspond to the color reference image.

According to another aspect of the present invention, there is provided a method of processing substrates in which each substrate is inspected soon after it is polished. In particular, each substrate is inspected after is subjected to a CMP process and is subsequently cleaned. First, a color image of the surface of the substrate is captured. The color image is image-processed into a processed color image in the form of data of the color and contrast of areas of the color image captured by the camera. The processed color image is then compared with a color reference image in the form of data stored in a database and, a determination is made on that basis as to whether a defect exists in the polishing process.

In particular, a defect in the polishing process is determined to exist when the processed color image of the surface of the substrate and the color reference image do not correspond to, e.g., match, each other. In this case, an interlock signal that stops the polishing process from being carried out on another substrate is generated.

### BRIEF DESCRIPTION OF THE DRAWINGS

The above and other objects, features and advantages of the present invention will become more apparent to those of ordinary skill in the art by referring to the following detailed description of the preferred embodiments thereof made with reference to the attached drawings in which:

FIG. 1 illustrates a schematic diagram of an apparatus for inspecting a wafer in chemical mechanical polishing (CMP) equipment according to the present invention;

FIG. 2A illustrates an image of the surface of a normally polished wafer;

FIG. 2B and 2C illustrate images of the surface of an abnormally polished wafer; and

FIG. 3 is a flow chart of a method of processing wafers which includes inspecting polished wafers according the present invention.

### DETAILED DESCRIPTION OF THE PREFERRED EMBODIMENTS

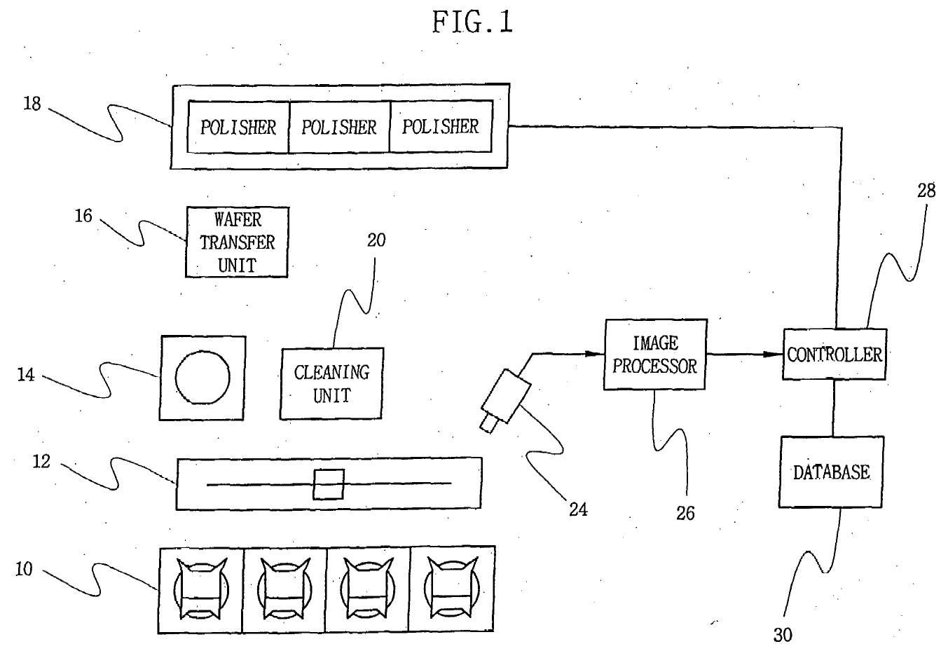

Referring to FIG. 1, chemical mechanical polishing (CMP) equipment according to the present invention has a cassette stage 10 configured to support a plurality of wafer cassettes, a wafer positioner 14 for holding wafers in a standby position, a cleaning unit 20 fordcleaning wafers, a transfer robot 12 interposed between the cassette stage 10 and both the wafer positioner 14 and cleaning unit 20, a main polishing unit 18, and a wafer transfer unit 16 interposed between the main polishing unit 18 and both the wafer positioner 14 and cleaning unit 20. The cassette stage 10 has the plurality of wafer cassettes mounted thereto. The wafer cassettes supported by the cassette stage 10 can each store at least one wafer. The transfer robot 12 has a working envelope that encompasses the cassette stage 10, the wafer positioner 14 and the cleaning unit 20 and is operative to transfer a wafer from a wafer cassette supported by the cassette stage 10 to the wafer positioner 14, and to transfer a wafer cleaned by the cleaning unit 20 to a wafer cassette supported by the cassette stage 10. The main polishing unit 18 has a plurality of polishing apparatus. Each polishing apparatus may include a platen assembly in which a polishing pad is attached to a rotating platen, a polishing head assembly that moves up and down above the platen assembly and is provided with a vacuum head for holding the wafer using suction, and a slurry supply system that supplies an abrasive slurry onto the polishing pad of the platen assembly. The wafer transfer unit 16 has a working envelope that encompasses the wafer positioner 14, the cleaning unit 20 and the main polishing unit 18 and is operative to transfer a wafer from the wafer positioner 14 to a polishing apparatus of the main polishing unit 18, and to transfer a polished wafer from a polishing apparatus of the main polishing unit 18 to the cleaning unit 20.

The CMP equipment also has apparatus for inspecting wafers that have been polished by the main polishing unit 18. The inspecting apparatus includes a camera 24 disposed near the cleaning unit 20, an image processor 26 operatively electronically connected to the camera 24 for processing images captured by the camera 24 and for outputting the processed images, a database 30 (electronic memory device) that stores reference images, and a controller 28. The controller 28 is operatively electronically connected to the image processor 26 so as to receive the processed images output by the image processor 26. The controller 28 is also operatively connected to the database 30 and is configured to selectively compare the processed images output by the image processor 26 with reference images stored in the database 30, to determine whether a defect exists in the polishing process on the basis of the comparison, and to generate an interlock signal for stopping the CMP process in the case in which the controller determines that a defect exists in the polishing process.

More specifically, the camera 24 is positioned to capture an image of the surface of each wafer which has been polished by the main polishing unit. The image processor 26 processes a color image of the surface of the wafer and outputs data representative of the color of and contrast between various areas of the surface of the wafer. The database 30 stores data of reference color images correlated with the CMP process conditions under which the surfaces of the wafers will exhibit such colors. That is, the color of the surface or area of the surface of the wafer may depend on the conditions under which the CMP process is carried out and the extent to which the surface is polished under such conditions. For example, a surface region of a wafer which has been polished normally by a CMP process will appear blue. In contrast, a surface region of a wafer which has been under polished or over polished by the same CMP process will appear yellow or light blue color. The database 30 may thus stores data of at least one reference color image in which regions of the image are blue.

A method of processing wafers according to the present invention will now be described with reference to FIGS. 1 through 3.

First, several wafer cassettes are mounted to the cassette stage 10. A plurality of wafers are stored in each cassette. The transfer robot 12 unloads one wafer from a specific one of the cassettes mounted to the cassette stage 10, and then transfers the wafer to the wafer positioner 14. Subsequently, the wafer transfer unit 16 transfers the wafer from the wafer positioner 14 to a specific one of the polishing apparatus of the polishing unit 18. Then, the polishing apparatus performs a CMP process on the wafer.

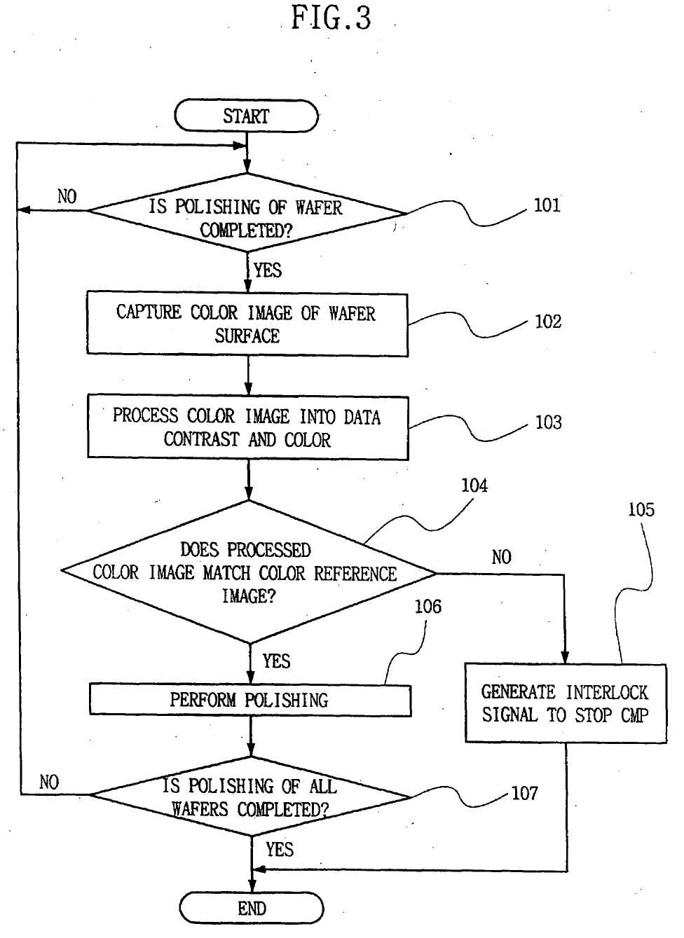

The controller 28 monitors the polishing unit 18 to determine whether the polishing of the wafer has been completed (S101 in FIG. 3). Once the wafer has been polished, the controller 28 controls the wafer transfer unit 16 to transfer the wafer to the cleaning unit 20, and controls the cleaning unit 20 to clean the wafer. Next, the wafer cleaned by the cleaning unit 20 is transferred by the transfer robot 12 from the cleaning unit 20 to a cassette mounted on the cassette stage 10. At this time the polished wafer is inspected by the inspecting apparatus of the present invention.

Specifically, the controller 28 controls the camera 24 to capture a color image of the surface of the wafer while the transfer robot 12 is transferring the wafer to the cassette stage 10 (S102). The controller 28 also controls the image processor 26 to process the color image captured by the camera 24 into data representative of the color of and contrast between various regions of the surface of the wafer (S103). Also, the controller 28 checks whether the processed color image corresponds to that of a reference color image stored in the database 30. The reference color image is selected from the database by the controller 28 based on the conditions under which the CMP process is being carried out. That is, the selected reference color image may be an idealized color image of a surface of a wafer polished and cleaned under the conditions prevailing in the CMP equipment.

The controller 28 generates an interlock signal that stops the CMP process from proceeding when the processed color image output by the image processor 26 does not correspond to that of the reference color image selected from the database 30 by the controller 28 (S105). In particular, the controller 28 applies the interlock signal to the polishing unit 18, thereby causing the polishing unit 18 to shut down. On the other hand, the controller 28 controls CMP equipment to effect the polishing of another wafer, in the manner described above, when the processed color image output by the image processor 26 corresponds to that of the reference color image selected from the database 30 by the controller 28 (S106).

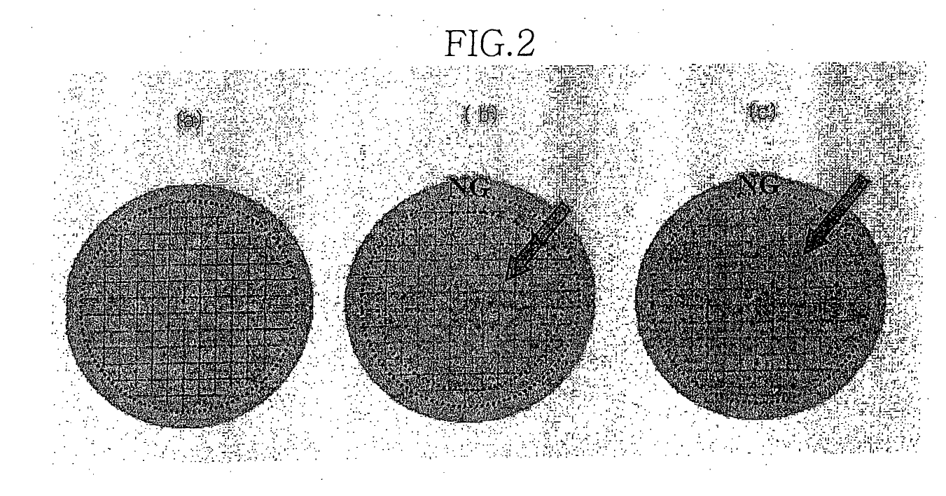

For example, the controller 28 determines that the CMP process is being performed normally when the processed color image of the surface of the wafer reveals no color differences across the entire surface as shown in FIG. 2A. On the other hand, the controller 28 determines that the CMP process is being performed abnormally when the processed color image of surface of the wafer reveals that an outer peripheral area of the surface has a uniform color but that the color is different from that at the central area of the surface, as shown in FIG. 2B. As another example, the controller 28 determines that the CMP process is being performed abnormally when the processed color image of surface of the wafer reveals that the color of the surface of the wafer varies across the entire surface of the wafer, as shown in FIG. 2C.

In the case in which the controller 28 determines that the CMP process is being performed normally, the controller 28 checks whether all of the wafers stored in a cassette or cassettes have been polished (S107). If so, the controller 28 terminates the program. If not, the controller 28 controls the CMP equipment to effect the polishing of the next wafer in the manner described above.

As described above, according to the present invention, the surface of the wafer surface is monitored in real time by capturing a color image of the surface of the wafer after each wafer is polished. Therefore, the present invention can prevent defects from occurring in a large number of wafers due to errors in the CMP process.

Finally, although the present invention has been described in connection with the preferred embodiments thereof, it is to be understood that the scope of the present invention is not so limited. On the contrary, various modifications of and changes to the preferred embodiments will be apparent to those of ordinary skill in the art. Thus, changes to and modifications of the preferred embodiments may fall within the true spirit and scope of the invention as defined by the appended claims.

What is claimed is:

1. In chemical mechanical polishing (CMP) equipment having a main polishing unit that performs a CMP polishing process on substrates, a cleaning unit that cleans substrates polished by the main polishing unit, and a transfer device that transfers a substrate cleaned by the cleaning unit along a path from the cleaning unit, apparatus for inspecting a wafer comprising:
a color camera disposed alongside the path along which a substrate is transferred by the transfer device from the cleaning unit, and oriented to capture a color image of the surface of the substrate;
an image processor electronically connected to the camera and operative to process color images captured by the camera and output processed images made up of data of the color and contrast of the color images captured by the camera;
a database that stores data of at least one color reference image; and
a controller electronically connected to the image processor so as to receive the processed images output by the image processor, and electronically connected to the database, the controller being configured to selectively compare a processed image output by the image processor with a reference image stored in the database, and the controller being configured to determine on the basis of the comparison whether a defect exists in the polishing process.

2. The equipment according to claim 1, wherein the database stores data of color reference images correlated with CMP process conditions.

3. The equipment according to claim 1, wherein the controller is electronically connected to the polishing unit and is operative to generate an interlock signal that shuts down the polishing unit, the controller being configured to generate the interlock signal when the processed image output by the image processor does not correspond to the color reference image.

4. A method of processing substrates, comprising:
performing a polishing process on a substrate;
subsequently capturing a color image of the surface of the substrate;
processing the color image into a processed color image in the form of data of the color and contrast of areas of the color image captured by the camera;
comparing the processed color image with a color reference image in the form of data stored in a database, and determining on the basis of the comparison whether a defect in the polishing process exists.

5. The method according to claim 4, further comprising generating an interlock signal that stops the polishing process from being carried out on another substrate when the defect in the polishing process is determined to exist.

6. The method according to claim 4, wherein a defect in the polishing process is determined to exist when the processed color image of the surface of the substrate and the color reference image do not correspond to each other.

7. The method according to claim 4, further comprising cleaning the substrate after the polishing process has been completed, and wherein the color image of the surface of the substrate is captured after the substrate is cleaned.

8. The method according to claim 7, further comprising transferring the cleaned substrate to a receptacle supported on a stage, and wherein the color image of the surface of the cleaned substrate is captured in the course of the transfer of the cleaned substrate to the receptacle supported on a stage.

9. The method according to claim 4, further comprising cleaning the substrate after the polishing process has been completed, and wherein the polishing process is a CMP (chemical mechanical polishing) process, and the color image of the surface of the substrate is captured after the substrate is cleaned.

10. The method according to claim 9, further comprising generating an interlock signal that shuts down a polishing apparatus when the defect in the CMP process is determined to exist.

11. The method according to claim 9, further comprising transferring the cleaned substrate to a receptacle supported on a stage, and wherein the color image of the surface of the cleaned substrate is captured in the course of the transfer of the cleaned substrate to the receptacle supported on a stage.
